(19) United States
(12) Patent Application Publication
(10) Pub. No.: US 2024/0017667 A1
(43) Pub. Date: Jan. 18, 2024

(54) BRAKE PEDAL PRESSURE INDICATION ASSEMBLY AND METHOD

(71) Applicants: Breydon Buehler, Avon, IN (US); Patrick Williams, Avon, IN (US)

(72) Inventors: Breydon Buehler, Avon, IN (US); Patrick Williams, Avon, IN (US)

(21) Appl. No.: 17/863,917

(22) Filed: Jul. 13, 2022

(51) Int. Cl. B60Q 1/44

(52) U.S. Cl. CPC B60Q 1/444; B60T 2270/88; B60Q 2400/20

(57) ABSTRACT

A brake pedal pressure indication assembly and method for indicating a pressure level applied to the brake includes a processor being integrated within a vehicle. The vehicle has a brake pedal and the processor has a pressure sensor being in mechanical communication with the brake pedal. The processor determines the amount of force applied to the pressure sensor relative to a set of levels. The set of levels further includes a low level tier, a high level tier, and a mid level tier. A pair of brake lights is in electric communication with the processor. Each of the brake lights has a bulb having a color-changing capability. A strip is in electric communication with the processor as well. The strip has a plurality of light emitting diodes having the color-changing capability.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle brake device and more particularly pertains to a new vehicle brake device for indicating a pressure level applied to the brake.

### (2) Description of Related Art Including Information Disclosed Under 37 CFR 1.97 and 1.98

The prior art relates to vehicle brake devices. The prior art includes a variety of vehicle brake devices used to indicate the pressure applied to a brake pedal. Known prior art lacks a vehicle brake device configured for indicating a pressure force applied to the brake pedal by emitting a color respective to a set of levels upon a pair of brake lights and a strip having a plurality of light emitting diodes.

### BRIEF SUMMARY OF THE INVENTION

An embodiment of the disclosure meets the needs presented above by generally comprising a processor being integrated within a vehicle. The vehicle is configured for having a brake pedal. The processor has a pressure sensor in mechanical communication with the brake pedal. The processor is configured for determining the amount of force applied to the pressure sensor relative to a set of levels. The set of levels further includes a low level tier. The low level tier is configured for including the amount of force applied being below a lower set pressure force. A high level tier is configured for including the amount of force applied being above a higher set force. A mid level tier is configured for including the amount of pressure force applied being from the lower set force to the higher set force. A pair of brake lights is in electric communication with the processor. Each of the brake lights has a bulb having a color-changing capability. A strip is in electric communication with the processor as well. The strip has a plurality of light emitting diodes having the color-changing capability.

Another embodiment of the disclosure includes a method comprising the step of applying an amount of force below a lower set force upon a brake pedal of a vehicle wherein a processor being configured for emitting a yellow light from a pair of brake lights and from a strip. Furthermore, applying the amount of force from the lower set force to a higher set force upon the brake pedal of the vehicle wherein the processor being configured for emitting an orange light from the pair of brake lights and from the strip. Additionally, applying the amount of force above the higher set force upon the brake pedal of the vehicle wherein the processor being configured for emitting a red light from the pair of brake lights and from the strip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a brake pedal pressure indication assembly and method according to an embodiment of the disclosure.

FIG. 2 is a side view of an embodiment of the disclosure.

FIG. 3 is a block diagram view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

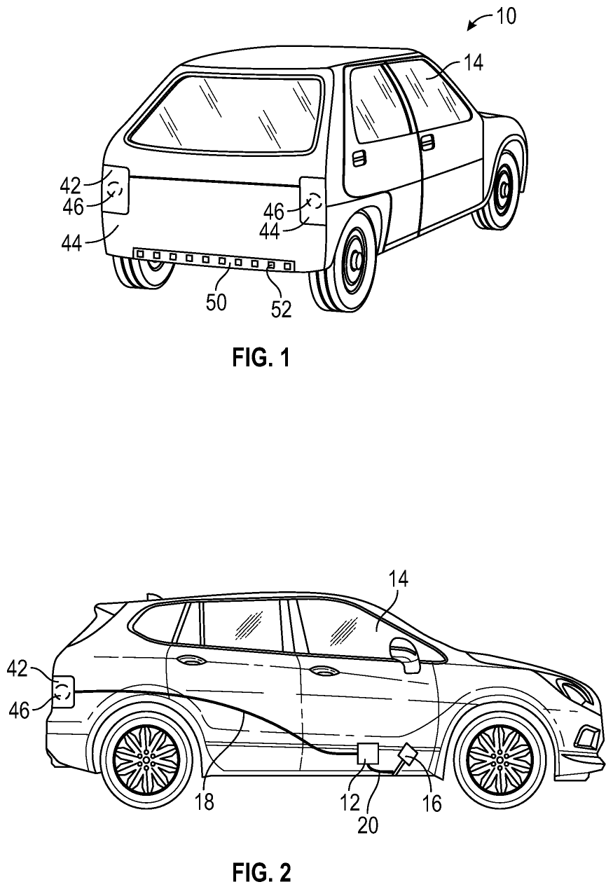

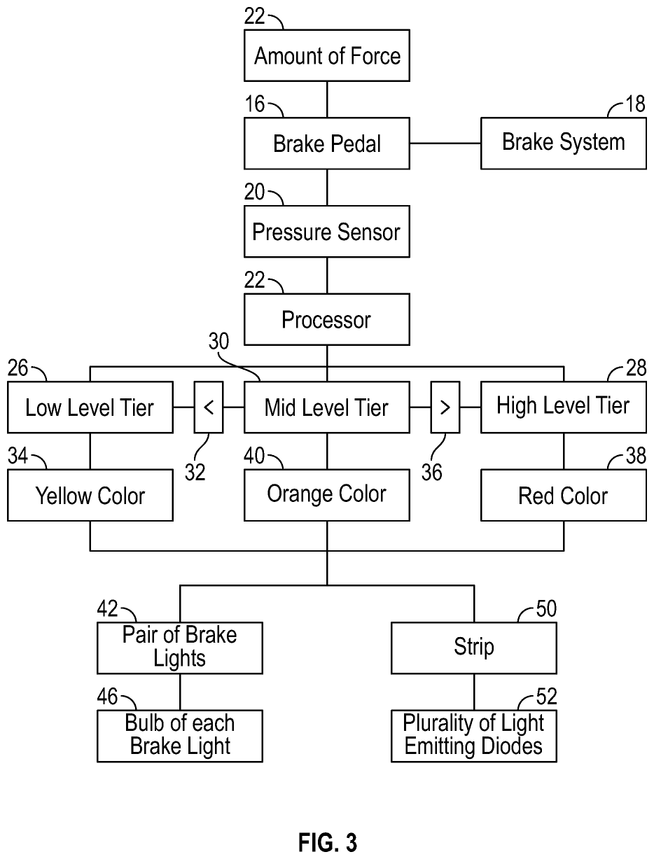

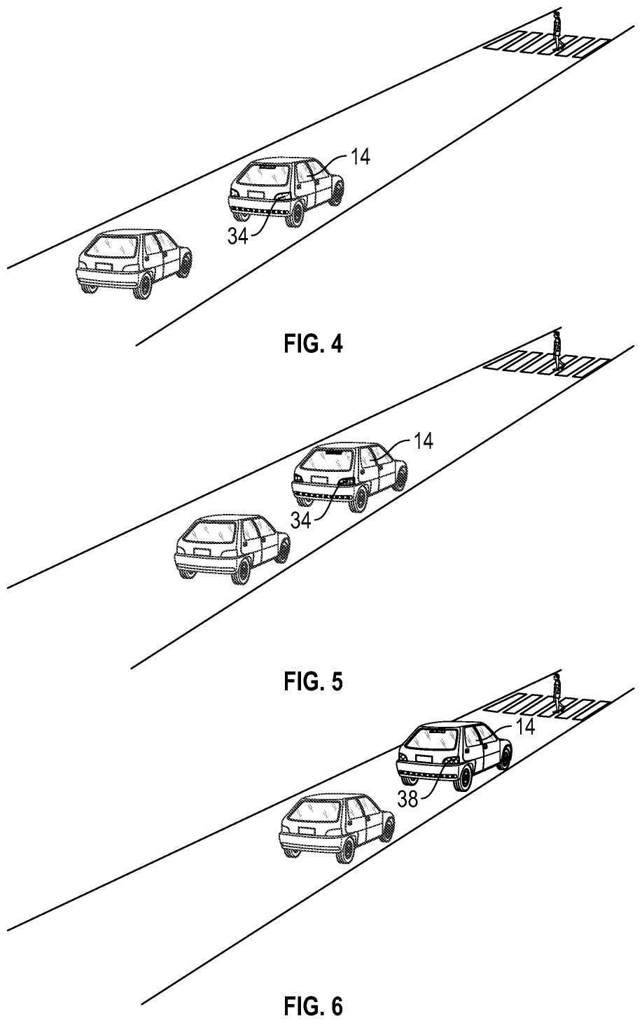

With reference now to the drawings, and in particular to FIGS. 1 through 6 thereof, a new vehicle brake device embodying the principles and concepts of an embodiment of the disclosure and generally designated by the reference numeral 10 will be described.

As best illustrated in FIGS. 1 through 6, the brake pedal pressure indication assembly and method 10 generally comprises a processor 12 being integrated within a vehicle 14. The vehicle 14 is configured for having a brake pedal 16 being able to apply a brake system 18 to reduce the speed of the vehicle 14. The processor 12 is a central processing unit having a pressure sensor 20. The pressure sensor 20 is in mechanical communication with the brake pedal 16 and is configured for recording the amount of force 22 applied to the brake pedal 16 from a foot of a driver.

The processor 12 is configured for determining the amount of force 22 applied to the pressure sensor 20 relative to a set of levels 24. The set of levels 24 further includes a low level tier 26, a high level tier 28, and a mid level tier 30. The low level tier 26 is configured for including the amount of force 22 applied being below a lower set force 32. The low lever tier 26 is configured for the processor 12 to emit a yellow color 34. The high level tier 28 is configured for including the amount of force 22 applied being above a higher set force 36. The high level tier 28 is configured for the processor 12 to emit a red color 38. The mid level tier 30 is configured for including the amount of force 22 applied being from the lower set force 32 to the higher set force 36. The mid level tier 30 is configured for the processor to emit an orange color 40.

A pair of brake lights 42 is in electric communication with the processor 12. The pair of brake lights 42 is configured for being positioned on a rear surface 44 of the vehicle 14. Each of the brake lights 42 is configured for illuminating when the amount of force 22 is applied to the brake pedal 16 wherein indicating the brake system 18 of the vehicle 14 is engaged. Each of the brake lights 42 has a bulb 46 having a color-changing capability 48. The color-changing capability 48 is configured for producing a variety of colors including the yellow color 34, the orange color 40, and the red color 38.

Furthermore, a strip 50 is in electric communication with the processor 12. The strip 50 is configured for being positioned on the rear surface 44 of the vehicle 14. The strip 50 has a plurality of light emitting diodes 52 being configured for illuminating when the amount of force 22 is applied to the brake pedal 16. The plurality of light emitting diodes 52 has the color-changing capability 48 wherein each of the light emitting diodes 52 can produce the yellow color 34, the orange color 40, and the red color 38.

In use, the driver of the vehicle 14 applies the amount of force 22 to the brake pedal 16 to engage the brake system 18 of the vehicle 14. When the user applies the amount of force 22 below the lower set force 32 upon the brake pedal 16 of the vehicle 14, then the processor 12 is configured for emitting the yellow light 34 from the pair of brake lights 42 and from the strip 50. Furthermore, when the user applies the amount of force 22 from the lower set force 32 to the higher set force 36 upon the brake pedal 16 of the vehicle 14, then the processor 12 is configured for emitting the orange light 40 from the pair of brake lights 42 and from the strip 50. Additionally, when the user applies the amount of force 22 above the higher set force 36 upon the brake pedal 16 of the vehicle 14, then the processor 12 is configured for emitting the red light 38 from the pair of brake lights 42 and from the strip 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A brake pedal pressure indicator assembly configured for emitting a color respective to a tier of pressure applied to a brake pedal, the brake pedal pressure indicator assembly comprising:
a processor being integrated within a vehicle, the vehicle being configured for having a brake pedal, the processor having a pressure sensor, the pressure sensor being in mechanical communication with the brake pedal, the processor being configured for determining the amount of force applied to the pressure sensor relative to a set of levels, the set of levels further including:
a low level tier being configured for including the amount of force applied being below a lower set force;
a high level tier being configured for including the amount of force applied being above a higher set force; and
a mid level tier being configured for including the amount of force applied being from the lower set force to the higher set force;
a pair of brake lights being in electric communication with the processor, each of the brake lights having a bulb, the bulb of each of the brake lights having a color-changing capability; and
a strip being in electric communication with the processor, the strip having a plurality of light emitting diodes, the plurality of light emitting diodes having the color-changing capability.

2. The brake pedal pressure indicator assembly of claim 1, further comprising the brake pedal being configured for applying a brake system to reduce the speed of the vehicle, the processor being a central processing unit.

3. The brake pedal pressure indicator assembly of claim 2, further comprising the pressure sensor being configured for recording the amount of pressure force applied to the brake pedal from a foot of a driver.

4. The brake pedal pressure indicator assembly of claim 3, further comprising the low lever tier being configured for the processor to emit a yellow color.

5. The brake pedal pressure indicator assembly of claim 4, further comprising the high level tier being configured for the processor to emit a red color.

6. The brake pedal pressure indicator assembly of claim 5, further comprising the mid level tier being configured for the processor to emit an orange color.

7. The brake pedal pressure indicator assembly of claim 6, further comprising the pair of brake lights being configured for being positioned on a rear surface of the vehicle, each of the brake lights being configured for illuminating when a force is applied to the brake pedal.

8. The brake pedal pressure indicator assembly of claim 7, further comprising the color-changing capability being configured for producing a variety of colors.

9. The brake pedal pressure indicator assembly of claim 7, further comprising the strip being configured for being positioned on the rear surface of the vehicle.

10. The brake pedal pressure indicator assembly of claim 9, further comprising the plurality of light emitting diodes being configured for illuminating when a force is applied to the brake pedal.

11. A brake pedal pressure indicator assembly configured for emitting a color respective to a tier of pressure applied to a brake pedal, the brake pedal pressure indicator assembly comprising:
a processor being integrated within a vehicle, the vehicle being configured for having a brake pedal, the brake pedal being configured for applying a brake system to reduce the speed of the vehicle, the processor being a central processing unit, the processor having a pressure sensor, the pressure sensor being in mechanical communication with the brake pedal, the pressure sensor being configured for recording the amount of force applied to the brake pedal from a foot of a driver, the processor being configured for determining the amount of force applied to the pressure sensor relative to a set of levels, the set of levels further including:
a low level tier being configured for including the amount of force applied being below a lower set force, the low lever tier being configured for the processor to emit a yellow color;
a high level tier being configured for including the amount of force applied being above a higher set force, the high level tier being configured for the processor to emit a red color; and
a mid level tier being configured for including the amount of force applied being from the lower set force to the higher set force, the mid level tier being configured for the processor to emit an orange color;
a pair of brake lights being in electric communication with the processor, the pair of brake lights being configured for being positioned on a rear surface of the vehicle, each of the brake lights being configured for illuminating when a force is applied to the brake pedal, each of the brake lights having a bulb, the bulb of each of the brake lights having a color-changing capability, the color-changing capability being configured for producing a variety of colors; and
a strip being in electric communication with the processor, the strip being configured for being positioned on the rear surface of the vehicle, the strip having a plurality of light emitting diodes, the plurality of light emitting diodes being configured for illuminating when a force is applied to the brake pedal, the plurality of light emitting diodes having the color-changing capability.

12. A method for using a brake pedal pressure indicator assembly, the method including the step of:
applying an amount of force below a lower set force upon a brake pedal of a vehicle, a processor being configured for emitting a yellow light from a pair of brake lights and from a strip;
applying the amount of force from the lower set force to a higher set force upon the brake pedal of the vehicle, the processor being configured for emitting an orange light from the pair of brake lights and from the strip; and
applying the amount of force above the higher set force upon the brake pedal of the vehicle, the processor being configured for emitting a red light from the pair of brake lights and from the strip.
